(19) United States
(12) Patent Application Publication
(10) Pub. No.: US 2005/0004278 A1
(43) Pub. Date: Jan. 6, 2005

(54) Flame-retardant thermoset compositions, their use and process for their preparation

(75) Inventors: Susanne Knop, Hamburg (DE); Martin Sicken, Koeln (DE); Sebastian Hoerold, Diedorf (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 10/840,972

(22) Filed: May 7, 2004

(30) Foreign Application Priority Data
May 13, 2003 (DE) 103 21 297.3

(51) Int. Cl. C08K 5/34; C08K 5/49; C09K 21/00

(52) U.S. Cl. 524/99; 252/609; 524/115

(57) ABSTRACT

The invention relates to flame-retardant thermoset composition which comprises, as flame retardant combination, at least one phosphinic salt of the formula (I), and/or one diphosphinic salt of the formula (II), and/or polymers of these (component A), 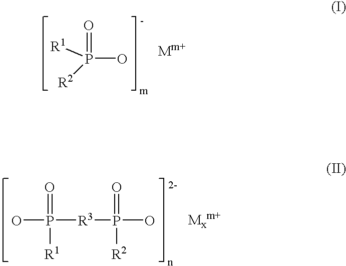 where
R¹ and R² are identical or different and are C₁-C₆-alkyl, linear or branched, and/or aryl;
R³ is C₁-C₁₀-alkylene, linear or branched, C₆-C₁₀-arylene, -alkylarylene, or -arylalkylene; M is Mg, Ca, Al, Sb, Sn, Ge, Ti, Zn, Fe, Zr, Ce, Bi, Sr, Mn, Li, Na, K, and/or a protonated nitrogen base; m is from 1 to 4; n is from 1 to 4; x is from 1 to 4, and also comprises at least one synergistic halogen-containing component (component B). The invention also relates to a process for preparing these flame-retardant thermoset compositions, and also to their use.

The invention relates to flame-retardant thermoset compositions, to a process for their preparation, and to their use.

Components made from thermoset resins, in particular those which have glass-fiber reinforcement, feature good mechanical properties, low density, substantial chemical resistance and excellent surface quality. This and their low cost has led to their increasing use as replacements for metallic materials in the application sectors of rail vehicles, the construction of buildings and air travel.

Unsaturated polyester resins (UP resins), epoxy resins (EP resins) and polyurethanes (PU resins) are combustible and therefore need flame retardants in some applications. Increasing demands in the market for fire protection and for environmental compatibility in products are increasing interest in halogen-free flame retardants, for example in phosphorus compounds or metal hydroxides.

Depending on the application sector, there are different requirements in relation to mechanical, electrical and fire-protection properties. In the rail vehicle sector in particular, fire-protection requirements have recently been made more stringent.

It is known that bromine- or chlorine-containing acid and/or alcohol components can be used to render unsaturated polyester resins flame-retardant. Examples of these components are hexachloroendomethylenetetrahydrophthalic acid (HET acid), tetrabromophthalic acid and dibromoneopentyl glycol. Antimony trioxide is often used as a synergist.

In JP 05245838 (CA 1993: 672700), aluminum hydroxide, red phosphorus and antimony trioxide are combined with a brominated resin to improve flame retardancy. A disadvantage of bromine- and chlorine-containing resins is that corrosive gases are produced in a fire, and this can result in considerable damage to electronic components, for example to relays in rail vehicles. Unfavorable conditions can also lead to the formation of polychlorinated or brominated dibenzodioxins and furans. There is therefore a requirement to reduce the proportion of halogen-containing flame retardants in unsaturated polyester resins and unsaturated polyester molding compositions.

It is known that unsaturated polyester resins and unsaturated polyester molding compositions may be provided with fillers, such as aluminum hydroxide. The elimination of water from aluminum hydroxide at elevated temperatures gives some degree of flame retardancy. At filler levels of from 150 to 200 parts of aluminum hydroxide per 100 parts of UP resin it is possible to achieve self-extinguishing properties and low smoke density. A disadvantage of systems of this type is their high specific gravity, and attempts are made to reduce this by adding, for example, hollow glass beads [Staufer, G., Sperl, M., Begemann, M., Buhl, D., Düll-Mühlbach, I., Kunststoffe 85 (1995), 4].

PL 159 350 (CA 1995: 240054) describes laminates made from unsaturated polyester resins with up to 180 parts of magnesium hydroxide. However, injection processes, which are extremely important industrially, cannot be used with formulations of this type, due to the high viscosity of the uncured UP resin with the aluminum hydroxide or, respectively, magnesium hydroxide.

The processes described at a later stage below for rendering unsaturated polyester resins flame-retardant likewise have a large number of disadvantages, in particular the requirement for a very high filler content.

To reduce total filler content, aluminum hydroxide can be combined with ammonium polyphosphate, as described in DE-A-37 28 629. JP 57016017 (CA96(22): 182248) describes the use of red phosphorus as a flame retardant for unsaturated polyester resins, and JP-55 094 918 (CA93(24): 22152t) describes the combination of aluminum hydroxide, red phosphorus and antimony trioxide.

PL 161 333 (CA 1994: 632278) achieves low smoke density and low-toxicity decomposition products by using aluminum hydroxide, magnesium hydroxide or basic magnesium carbonate, red phosphorus and, if desired, finely dispersed silica. DE-A-2 159 757 moreover claims the use of melamine and aluminum hydroxide.

Since aluminum hydroxide on its own is not a very effective flame retardant for unsaturated polyester resins or for epoxy resins, combinations with red phosphorus are also proposed, in order to reduce the filler content. A disadvantage here, however, is the red intrinsic color of the product, limiting its use to components with dark pigmentation.

Unsaturated polyester resins are solutions, in copolymerizable monomers, preferably styrene or methyl methacrylate, of polycondensation products made from saturated and unsaturated dicarboxylic acids, or from anhydrides of these, together with diols. UP resins are cured by free-radical polymerization using initiators (e.g. peroxides) and accelerators. The double bonds in the polyester chain react with the double bond in the copolymerizable solvent monomer. The most important dicarboxylic acids for preparing the polyesters are maleic anhydride, fumaric acid and terephthalic acid. The diol most frequently used is 1,2-propanediol. Use is also made of ethylene glycol, diethylene glycol and neopentyl glycol, inter alia. The most suitable crosslinking monomer is styrene. Styrene is fully miscible with the resins and copolymerizes readily. The styrene content in unsaturated polyester resins is normally from 25 to 40%. A monomer which can be used instead of styrene is methyl methacrylate.

Unsaturated polyester resins differ in their chemical and physical properties and in their fire performance significantly from the similarly named polyesters, which, however, in contrast to the aforementioned unsaturated polyester resins, are thermoplastic polymers. These polyesters are also prepared by completely different processes than those as described in the preceding paragraph for the unsaturated polyester resins. Polyesters can be prepared, for example, by ring-opening polymerization of lactones or by polycondensation of hydroxycarboxylic acids, in which case polymers of the general formula —[O—R—(CO)]— are obtained. The polycondensation of diols and dicarboxylic acids and/or derivatives of dicarboxylic acids produces polymers of the general formula —[O—R¹—O—(CO)—R²—(CO)]—. Branched and crosslinked polyesters can be obtained by polycondensation of alcohols having a functionality of three or more with polyfunctional carboxylic acids.

Unsaturated polyester resins and polyesters are therefore two completely different polymers and represent completely different polymer groups.

Another group of thermosets, epoxy resins, are nowadays used for preparing molding compositions and coatings with a high level of thermal, mechanical and electronic properties.

Epoxy resins are compounds prepared by a polyaddition reaction of an epoxy resin component with a crosslinking (hardener) component. The epoxy resin components used are aromatic polyglycidyl esters, such as bisphenol A diglycidyl ester, bisphenol F diglycidyl ester or polyglycidyl esters of phenol-formaldehyde resins or cresol-formaldehyde resins, or pqlyglycidyl esters of phthalic, isophthalic or terephthalic acid, or else of trimellitic acid, N-glycidyl compounds of aromatic amines or of heterocyclic nitrogen bases, or else di- or polyglycidyl compounds of polyhydric aliphatic alcohols.

Hardeners which are used are polyamines, such as triethylenetetramine, aminoethylpiperazine or isophoronediamine, polyamidoamines, polybasic acids or anhydrides of these, e.g. phthalic anhydride, hexahydrophthalic anhydride or methyltetrahydrophthalic anhydride, or phenols. The crosslinking may also take place via polymerization using suitable catalysts.

Epoxy resins are suitable for the potting of electrical or electronic components, and for saturation and impregnation processes. The epoxy resins used in electrical engineering are predominantly flame-retardant and used for printed circuit boards or insulators.

In the prior art, epoxy resins for printed circuit boards are currently rendered flame-retardant by including bromine-containing aromatic compounds in the reaction, in particular tetrabromobisphenol A. A disadvantage is that hydrogen bromide (a dangerous substance) is liberated in a fire, and this can cause corrosion damage. Under unfavorable conditions, polybrominated dibenzodioxins and furans can also be produced. It is therefore desirable to reduce the content of halogen-containing flame retardants. The use of aluminum hydroxide is completely excluded since it eliminates water when processed.

Fire-protection requirements for electrical and electronic equipment are laid down in specifications and standards for product safety. In the US, fire-protection testing and approval procedures are carried out by Underwriters Laboratories (UL), and UL specifications are nowadays accepted worldwide. The fire tests for plastics were developed in order to determine the resistance of the materials to ignition and flame spread.

The materials have to pass horizontal burning tests (Classification UL 94HB) or the more stringent vertical tests (UL 94 V-2, V-1 or V-0), depending on the fire-protection requirements. These tests simulate low-energy ignition sources which occur in electrical devices and to which plastic parts in electrical modules can be exposed.

Surprisingly, it has now been found that salts of phosphinic acids in combination with a number of synergistic halogen-containing compounds prove to be effective flame retardants for thermoset resins, such as unsaturated polyester resins or epoxy resins.

Alkali metal salts of phosphinic acids have previously been proposed as flame-retardant additives for thermoplastic polyesters (DE-A-44 30 932). They have to be added in amounts of up to 30% by weight. The salts of phosphinic acids with an alkali metal or with a metal of the second or third main group of the Periodic Table, in particular the zinc salts (DE-A-2 447 727), have also been used to prepare flame-retardant polyamide molding compositions. There is a marked difference in fire performance between thermoplastic polyesters, such as PET and PBT, and thermosetting polyesters, such as unsaturated polyester resins: in a fire thermoplastic materials produce drops of falling material, but thermosetting materials do not melt or produce drops of falling material.

The invention therefore provides flame-retardant thermoset compositions which comprise, as flame retardant combinations, at least one phosphinic salt of the formula (I) and/or one diphosphinic salt of the formula (II), and/or polymers of these (component A), 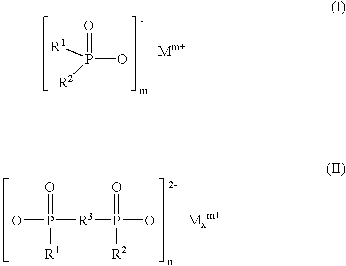
where
R¹ and R² are identical or different and are C₁-C₆-alkyl, linear or branched, and/or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Zn, Fe, Zr, Ce, Bi, Sr, Mn, Li, Na, K, and/or a protonated nitrogen base;
m is from 1 to 4;
n is from 1 to 4;
x is from 1 to 4,
   and also comprise at least one synergistic halogen-containing component B.
M is preferably calcium, aluminum, or zinc.

Protonated nitrogen bases are preferably the protonated bases of ammonia, melamine, triethanolamine, and in particular NH₄+.

Preferred meanings of R¹ and R², identical or different, are C₁-C₆-alkyl, linear or branched, and/or phenyl.

Preferred meanings of R¹ and R², identical or different, are methyl, ethyl, n-propyl, isopropyl, n-butyl, tert-butyl, n-pentyl and/or phenyl.

Preferred meanings of R³ are methylene, ethylene, n-propylene, isopropylene, n-butylene, tert-butylene, n-pentylene, n-octylene or n-dodecylene.

Other preferred meanings of R³ are phenylene or naphthylene.

Other preferred meanings of R³ are methylphenylene, ethylphenylene, tert-butylphenylene, methylnaphthylene, ethylnaphthylene or tert-butylnaphthylene.

Other preferred meanings of R³ are phenylmethylene, phenylethylene, phenylpropylene or phenylbutylene.

The halogen-containing component B preferably comprises bromine- or chlorine-containing acid components or bromine- or chlorine-containing alcohol components, or bromine- or chorine-containing aromatic and aliphatic compounds.

The bromine- or chlorine-containing acid components or bromine- or chlorine-containing alcohol components preferably comprise hexachloroendomethylene-tetrahydrophthalic acid, tetrabromophthalic acid, tetrabromophthalic anhydride, dibromoneopentyl glycol, trischloroethyl phosphate, and/or trischloropropyl phosphate.

The bromine- or chlorine-containing aromatic and aliphatic compounds preferably comprise tetrabromobisphenol A, decabromodiphenyl ether, hexabromocyclododecane, chloroparaffins, and/or dodecachloropentacyclooctadecadiene.

The inventive flame retardant combination preferably comprises, as further component C, at least one nitrogen compound, phosphorus compound, or phosphorus-nitrogen compound.

Component C preferably comprises melamine phosphate, dimelamine phosphate, melamine pyrophosphate, melamine polyphosphates, melam polyphosphates, melem polyphosphates, and/or melon polyphosphates.

Component C preferably comprises melamine condensates, such melam, melem and/or melon.

Component C preferably comprises nitrogen compounds of the formulae (III) to (VIII), or a mixture of these, 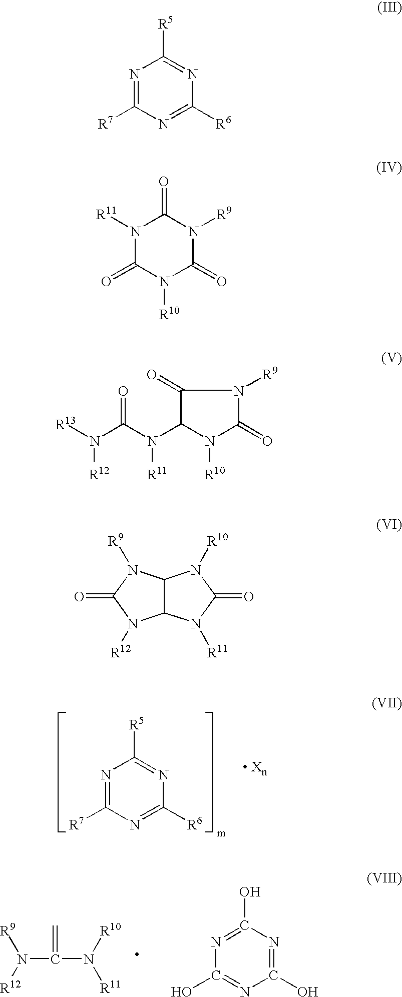
where
R⁵ to R⁷ are hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy, C₆-C₁₂-aryl or -arylalkyl, —OR⁸, or —N(R⁸)R₉, or else a system of N-alicyclic or N-aromatic nature,
R⁸ is hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy, or C₆-C₁₂-aryl or -arylalkyl,
R⁹ to R¹³ are the same as the groups for R⁸, or else —O—R⁸,
m and n, independently of one another, are 1, 2, 3, or 4,
X is acids which can form adducts with triazine compounds (III).

Component C preferably comprises oligomeric esters of tris(hydroxyethyl) isocyanurate with aromatic polycarboxylic acids, or comprises benzoguanamine, tris(hydroxyethyl) isocyanurate, allantoin, glycoluril, melamine, melamine cyanurate, dicyandiamide, guanidine, and/or carbodiimides.

The inventive flame retardant combination preferably comprises nitrogen-containing phosphates of the formulae (NH₄)_{y} H_{3-y} PO₄ or (NH₄ PO₃)_{z}, where y is from 1 to 3 and z is from 1 to 10 000.

The inventive flame-retardant combination preferably comprises, as component D, a synthetic inorganic compound, and/or a mineral product.

Component D preferably comprises an oxygen compound of silicon, magnesium compounds, metal carbonates of metals of the second main group of the Periodic Table, red phosphorus, zinc compounds, or aluminum compounds.

The oxygen compounds of silicon preferably comprise salts and esters of orthosilicic acid and condensates thereof, silicates, zeolites, and silicas, glass powder, glass-ceramic powder, or ceramic powder; the magnesium compounds comprise magnesium hydroxide, hydrotalcites, magnesium carbonates, or magnesium calcium carbonates; the zinc compounds comprise zinc oxide, zinc stannate, zinc hydroxystannate, zinc phosphate, zinc borate, or zinc sulfides; the aluminum compounds comprise aluminum hydroxide or aluminum phosphate.

The inventive flame-retardant thermoset compositions preferably comprise from 0.1 to 30 parts by weight of at least one phosphinic salt of the formula (I) and/or one diphosphinic salt of the formula (II), and/or polymers of these (component A), and from 0.1 to 50 parts by weight of halogen-containing component B, for every 100 parts by weight of thermoset composition.

The inventive flame-retardant thermoset compositions preferably comprise from 1 to 15 parts by weight of at least one phosphinic salt of the formula (I) and/or one diphosphinic salt of the formula (II), and/or polymers of these (component A), and from 1 to 20 parts by weight of halogen-containing component B, for every 100 parts by weight of thermoset composition.

The inventive flame-retardant thermoset compositions preferably comprise from 1 to 15 parts by weight of phosphinic salt of the formula (I) and/or a diphosphinic salt of the formula (II), and/or polymers of these (component A), from 1 to 20 parts by weight of halogen-containing component B, and also from 0 to 15 parts by weight of each of component C and D, for every 100 parts by weight of thermoset composition.

The invention also provides flame-retardant thermoset compositions which comprise molding compositions, coatings, or laminates composed of thermoset resins.

The thermoset resins are preferably unsaturated polyester resins or epoxy resins.

The invention also provides a process for preparing flame-retardant thermoset compositions, which comprises mixing a thermoset resin with a flame retardant combination composed of at least one phosphinic salt of the formula (I) and/or one diphosphinic salt of the formula (II), and/or polymers of these (component A) with at least one synergistic halogen-containing component B, and wet-pressing (cold-pressing) the resultant mixture at pressures of from 3 to 10 bar and temperatures of from 20 to 60° C.

The invention also provides a process for preparing flame-retardant thermoset compositions, which comprises mixing a thermoset resin with a flame retardant combination composed of at least one phosphinic salt of the formula (I) and/or one diphosphinic salt of the formula (II), and/or polymers of these (component A) with at least one synergistic halogen-containing component B, and wet-pressing (warm- or hot-pressing) the resultant mixture at pressures of from 3 to 10 bar and temperatures of from 18 to 150° C.

Another process for preparing flame-retardant thermoset compositions of the present invention comprises mixing a thermoplastic resin with a flame retardant combination composed of at least one phosphinic salt of the formula (I) and/or one diphosphinic salt of the formula (II), and/or polymers of these (component A) with at least one synergistic halogen-containing component B, and manufacturing synthetic resin mats from the resultant mixture at pressures of from 50 to 150 bar and temperatures of from 140 to 160° C.

Prepregs can be produced by mixing a solvent-containing thermoset resin with components A and B, using this mixture to wet a reinforcing material, and permitting this to begin reaction at pressures of from 1 to 20 bar and temperatures of 100 to 200° C., thus producing press-ready prepregs by the above methods.

Components C and/or D may, if required, be added/incorporated at an appropriate point during the abovementioned processes.

The salts of the phosphinic acids used according to the invention may be prepared by known methods, these being described in more detail by way of example in EP-A-0 699 708.

As is shown in the examples below, when halogen-containing components and salts of phosphinic acids of the formula (I) or (II) are tested in isolation in thermoset resins, they have low activity.

Surprisingly, it has now been found that a combination composed of phosphinic salts and halogen-containing components is suitable for achieving the best combustibility classification for thermoset plastics, V-0 in the UL 94 vertical test.

The following compounds were used in the examples:

®Alpolit SUP 403 BMT (Vianova Resins GmbH, Wiesbaden, Germany), unsaturated polyester reins, about 57% strength in styrene, acid number not more than 30 mg KOH/g, pre-accelerated and adjusted so as to be slightly thixotropic, low viscosity (viscosity in 4 mm flow cup: 110±10 s) and greatly reduced styrene emission.

®Palatal 340 S (DSM-BASF Structural Resins, Ludwigshafen, Germany) unsaturated polyester resin, about 49% strength in styrene and methyl methacrylate, density 1.08 g/ml, acid number 7 mg KOH/g, pre-accelerated, low viscosity (dynamic viscosity about 50 mPa*s).

®Beckopox EP 140 (Vianova Resins GmbH, Wiesbaden, Germany), low-molecular-weight condensate composed of bisphenol A and epichlorohydrin with a density of 1.16 g/ml and an epoxy equivalent of 180-192.

®Beckopox EH 625 (Vianova Resins GmbH, Wiesbaden, Germany), modified aliphatic polyamine with an active-H equivalent weight of 73 and a dynamic viscosity of about 1000 mPa*s

®Modar 835 S (Ashland Composite Polymers Ltd, Kidderminster, GB) modified acrylate resin, dissolved in styrene, viscosity about 55 mPa*s at 25° C.

NL 49P cobalt accelerator (Akzo Chemie GmbH, Düren, Germany) cobalt octoate solution in dibutyl phthalate with a cobalt content of 1% by weight.

NL 63-10S cobalt accelerator (Akzo Chemie GmbH, Düren, Germany)

®Butanox M 50 (Akzo Chemie GmbH, Düren, Germany) methyl ethyl ketone peroxide, phlegmatized with dimethyl phthalate, clear liquid with an active oxygen content of at least 9% by weight.

Lucidol BT 50 dibenzoyl peroxide (Akzo Chemie GmbH, Düren, Germany) DEPAL: aluminum salt of diethylphosphinic acid

Production of Test Specimens

The thermoset resin and the flame retardant components, and also other additives where appropriate, are mixed homogeneously, using a dissolver disk. The mixture is homogenized again after addition of the hardener.

In the case of unsaturated polyester resins, the resin is mixed with the cobalt accelerator, the flame retardant components are added, and the curing is initiated by the addition of the peroxide after homogenization.

In the case of epoxy resins, the flame retardant components of the epoxy resin component are added and mixed homogeneously. The amine hardener or the anhydride hardener is then added to these.

Two layers of continuous glass textile mat whose weight per unit area is 450 g/m² are inserted within a heated press, on a ®Hostaphan release film and a steel frame. About half of the resin/flame retardant mixture is then uniformly distributed. Another glass mat is added, and then the remaining resin/flame retardant mixture is distributed, the laminate is covered with a release film, and a pressure plaque of thickness 4 mm is produced at a temperature of 50° C. over a period of one hour, using a pressure of 10 bar.

The fire performance test was carried out to the Underwriters Laboratories “Test for Flammability of Plastics Materials—UL 94” specification, issue dated May 2, 1975, on test specimens of length 127 mm, width 12.7 mm and various thicknesses.

Oxygen index was determined in a modified apparatus, on the basis of ASTM D2863-74.

1. Results with Unsaturated Polyester Resins

Table 1 shows comparative examples with sole use, and an inventive example with combined use, of halogen-containing components and DEPAL as flame retardant for an unsaturated polyester resin (Viapal UP 403 BMT).

With the inventive combination of DEPAL with halogen-containing component, a V-0 classification can be achieved at a laminate thickness of 1.6 mm by only 10 parts of DEPAL with addition of 10 parts of TCPP for every 100 parts of unsaturated polyester resin. The laminates may be colored as desired. The low filler content means that these UP resin laminates can be produced by the injection process.

TABLE 1
Combustion performance of unsaturated polyester
resin laminates to UL 94, 30% by weight of
continuous glass textile mat, laminate thickness
1.5 mm, Viapal UP 403 BMT resin, Butanox M50
hardener, NL 49 P accelerator

| | Flame retardant | UL 94 | |
|---|---|---|---|
| Example No. | parts/100 parts resin | classification | LOI |
| 1 | 25 DEPAL* | n.c. | 0.33 |
| 2 | 25 TCPP | n.c. | 0.31 |
| 3 | 50 TCPP | V-0 | 0.38 |
| 4 | 10 DEPAL + 10 TCPP | V-0 | 0.41 |

*DEPAL = aluminum diethylphosphinate
n.c. = not classifiable in the UL 94 vertical test

2. Results with Epoxy Resins

Table 2 shows flame tests using a polyamine-hardened epoxy resin (Beckopox EP 140 resin, Beckopox EH 625 hardener). V-0 classification at a laminate thickness of 1.5 mm can be achieved by the combination of DEPAL with halogen-containing component, by adding a total of 10 parts of solid flame retardant for every 100 parts of epoxy resin. In contrast, up to 150 parts of flame retardant do not achieve UL 94 V-0 when the components are used in isolation.

TABLE 2
Fire performance of epoxy resin moldings to UL 94,
thickness of material 1.6 mm
100 parts of Beckopox EP 140 resin, 39 parts of
Beckopox EH 625 hardener

| Example | Flame retardant | UL 94- | |
|---|---|---|---|
| No. | parts/100 parts resin | classification | LOI |
| 5 (comp.) | 10 DEPAL | n.c. | 0.27 |
| 6 (comp.) | 20 DEPAL | V-1 | 0.32 |
| 7 (comp.) | 20 tetrabromobisphenol A | n.c. | 0.25 |
| 8 | 10 DEPAL + 10 tetrabromobisphenol A | V-0 | 0.36 |

1. A flame-retardant thermoset composition comprising, as flame retardant combination, a component A, wherein component A is at least one phosphinic salt of the formula (I), at least one diphosphinic salt of the formula (II), at least one polymer of the at least one phosphinic salt, at least one polymer of the at least one diphosphinic salt or mixtures thereof 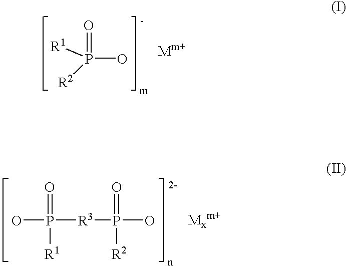
where
R¹ and R² are identical or different and are C₁-C₆-alkyl, linear or branched, or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Zn, Fe, Zr, Ce, Bi, Sr, Mn, Li, Na; K, or a protonated nitrogen base;
m is from 1 to 4;
n is from 1 to 4;
x is from 1 to 4,
and a component B, wherein component B is at least one synergistic halogen-containing component.

2. The flame-retardant thermoset composition as claimed in claim 1, wherein R¹ and R² are identical or different, and are C₁-C₆-alkyl, linear or branched, or phenyl.

3. The flame-retardant thermoset composition as claimed in claim 1, wherein R¹ and R² are identical or different and are methyl, ethyl, n-propyl, isopropyl, n-butyl, tert-butyl, n-pentyl, or phenyl.

4. The flame-retardant thermoset composition as claimed in claim 1, wherein R³ is methylene, ethylene, n-propylene, isopropylene, n-butylene, tert-butylene, n-pentylene, n-octylene, n-dodecylene; phenylene, naphthylene; methylphenylene, ethylphenylene, tert-butylphenylene, methylnaphthylene, ethylnaphthylene, tert-butylnaphthylene; phenylmethylene, phenylethylene, phenylpropylene, or phenylbutylene.

5. The flame-retardant thermoset composition as claimed in claim 1, wherein the halogen-containing component B further comprises bromine- or chlorine-containing acid components, bromine- or chlorine-containing alcohol components, bromine- or chorine-containing aromatic compounds or bromine- or chlorine-containing aromatic compounds.

6. The flame-retardant thermoset composition as claimed in claim 5, wherein the bromine- or chlorine-containing acid components are selected from the group consisting of hexachloroendomethylenetetrahydrophthalic acid, tetrabromophthalic acid, tetrabromophthalic anhydride, trischloroethyl phosphate, and trischloropropyl phosphate.

7. The flame-retardant thermoset composition as claimed in claim 5, wherein the bromine- or chlorine-containing aromatic compounds are selected from the group consisting of tetrabromobisphenol A, decabromodiphenyl ether, hexabromocyclododecane, and dodecachloropentacyclooctadecadiene.

8. The flame-retardant thermoset composition as claimed in claim 1, further comprising a component C selected from the group consisting of at least one nitrogen compound, at least one phosphorus compound, and at least one phosphorus-nitrogen compound.

9. The flame-retardant thermoset composition as claimed in claim 8, wherein component C is selected from the group consisting of melamine phosphate, dimelamine phosphate, melamine pyrophosphate, melamine polyphosphates, melam polyphosphates, melem polyphosphates and melon polyphosphates.

10. The flame-retardant thermoset composition as claimed in claim 8, wherein component C is selected from the group consisting of melamine condensates.

11. The flame-retardant thermoset composition as claimed in claim 8, wherein component C is at least one nitrogen compound of the formulae (III) to (VIII), or a mixture thereof, 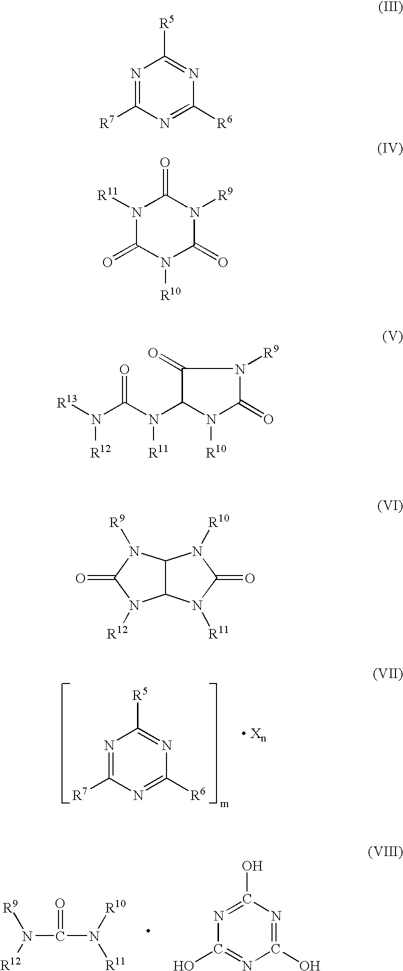
where
R⁵ to R⁷ are hydrogen, C₁-C₈-alkyl, C₅-C₁₆-cycloalkyl or -alkylcycloalkyl, C₂-C₈-alkenyl, C₁-C₈-alkoxy, -acyl, -acyloxy, C₆-C₁₂-aryl or -arylalkyl, —OR⁸, —N(R⁸)R⁹, or a system of N-alicyclic or N-aromatic nature,
R⁸ is hydrogen, C₁-C₈-alkyl, C₅-C₁₆-cycloalkyl or -alkylcycloalkyl, C₂-C₈-alkenyl, C₁-C₈-alkoxy, -acyl, -acyloxy, or C₆-C₁₂-aryl or -arylalkyl,
R⁹ to R¹³ are the same as the groups for R⁸, or —O—R⁸,
m and n, independently of one another, are 1, 2, 3, or 4,
X is an acid which can form adducts with triazine compounds (III).

12. The flame-retardant thermoset composition as claimed in claim 8, wherein component C is selected from the group consisting of oligomeric esters of tris(hydroxyethyl) isocyanurate with aromatic polycarboxylic acids, benzoguanamine, tris(hydroxyethyl) isocyanurate, allantoin, glycoluril, melamine, melamine cyanurate, dicyandiamide, guanidine, and carbodiimides.

13. The flame-retardant thermoset composition as claimed in claim 8, wherein component C is a nitrogen-containing phosphate of the formulae (NH₄)_{y} H_{3-y} PO₄ or (NH₄PO₃)_{z}, where y is from 1 to 3 and z is from 1 to 10 000.

14. The flame-retardant thermoset composition as claimed in claim 1, further comprising a component D selected from the group consisting of a synthetic inorganic compound and a mineral product.

15. The flame-retardant thermoset composition as claimed in claim 14, wherein component D is selected from the group consisting of an oxygen compound of silicon, a magnesium compound, a metal carbonate of metals of the second main group of the Periodic Table, red phosphorus, a zinc compound, and an aluminum compound.

16. The flame-retardant thermoset composition as claimed in claim 15, wherein the oxygen compound of silicon is selected from the group consisting of salts and esters of orthosilicic acid and condensates thereof, silicates, zeolites, silicas, glass powder, glass-ceramic powder, and ceramic powder.

17. The flame-retardant thermoset composition as claimed in claim 1, further comprising from 0.1 to 30 parts by weight of component A and from 0.1 to 50 parts by weight of component B, for every 100 parts by weight of the thermoset composition.

18. The flame-retardant thermoset composition as claimed in claim 1, further comprising from 1 to 15 parts by weight of component A and from 1 to 20 parts by weight of component B, for every 100 parts by weight of the thermoset composition.

19. (Cancelled)

20. A thermoset resin comprising a flame-retardant thermoset composition as claimed in claim 1, wherein the thermoset resin is a molding composition, coating, or laminate.

21. The resin as claimed in claim 20, wherein the thermoset resin is an unsaturated polyester or epoxy.

22. A process for preparing a flame-retardant thermoset composition as claimed in claim 1, comprising the steps of mixing a thermoset resin with a component A and component B as defined in claim 1 to form a mixture, and wet-pressing the mixture at a pressure of from 3 to 10 bar and a temperature of from 20 to 60° C.

23. A process for preparing flame-retardant thermoset composition as claimed in claim 1, comprising the steps of mixing a thermoset resin with a component A and component B as defined in claim 1 to form a mixture, and wet-pressing the mixture at a pressure of from 3 to 10 bar and a temperature of from 80 to 150° C.

24. A process for preparing a synthetic resin mat comprising the steps of mixing a thermoset resin with a flame retardant composition as claimed in claim 1 to form a mixture, and manufacturing the synthetic resin mat from the mixture at a pressure of from 50 to 150 bar and a temperature of from 140 to 160° C.

25. (Cancelled)

26. The flame-retardant thermoset composition as claimed in claim 5, wherein the bromine- or chlorine-containing alcohol component is dibromoneopentyl glycol.

27. The flame-retardant thermoset composition as claimed in claim 5, wherein the bromine- or chlorine-containing aliphatic compounds are chloroparaffins.

28. The flame-retardant thermoset composition as claimed in claim 11, wherein R⁵ to R⁷ and R⁸ are C₁-C₈-alkyl, C₅-C₁₆-cycloalkyl or -alkylcycloalkyl substituted with a hydroxy or C₁-C₄ hydroxyalkyl.

29. The flame-retardant thermoset composition as claimed in claim 15, wherein the magnesium compound is selected from the group consisting of magnesium hydroxide, hydrotalcites, magnesium carbonates, and magnesium calcium carbonates.

30. The flame-retardant thermoset composition as claimed in claim 15, wherein the zinc compound is selected from the group consisting of zinc oxide, zinc stannate, zinc hydroxystannate, zinc phosphate, zinc borate, and zinc sulfides.

31. The flame-retardant thermoset composition as claimed in claim 15, wherein the aluminum compound is aluminum hydroxide or aluminum phosphate.
